(19) United States
(12) Patent Application Publication
(10) Pub. No.: US 2015/0149975 A1
(43) Pub. Date: May 28, 2015

(54) METHOD AND APPARATUS FOR PROVIDING A DESIGN DIAGRAM OF A SEMICONDUCTOR DEVICE

(71) Applicant: SAMSUNG ELECTRONICS CO., LTD., Suwon-si (KR)

(72) Inventor: JEONG-SIK YU, Yongin-si (KR)

(21) Appl. No.: 14/513,415

(22) Filed: Oct. 14, 2014

(30) Foreign Application Priority Data
Nov. 22, 2013 (KR) 10-2013-0142843

(51) Int. Cl. G06F 17/50

(52) U.S. Cl. CPC G06F 17/5072
USPC 716/119

(57) ABSTRACT

A method for providing a design diagram of a semiconductor device is provided. The method includes generating a circuit diagram representing connections among a supply voltage, a ground voltage and a plurality of components in the semiconductor device and displaying a plurality of layout restrictions on the circuit diagram by using a plurality of graphic symbols.

### CROSS-REFERENCE TO RELATED APPLICATION

This application claims priority under 35 U.S.C. §119 to Korean Patent Application No. 10-2013-0142843, filed on Nov. 22, 2013 in the Korean Intellectual Property Office (KIPO), the disclosure of which is incorporated by reference herein in its entirety.

### TECHNICAL FIELD

The present inventive concept relates to a semiconductor design, and more particularly to a method and an apparatus for providing a design diagram of a semiconductor device.

### DISCUSSION OF THE RELATED ART

As a semiconductor device becomes smaller, components in the semiconductor device and wirings between the components may become densely integrated. A layout of the components and the wirings in the densely configured semiconductor device become more important in implementing the semiconductor device on a printed circuit board.

Therefore, information about the layout of the components and wirings may be used to better implement the semiconductor device on the printed circuit board.

### SUMMARY

According to an exemplary embodiment of the present inventive concept, a method for providing a design diagram of a semiconductor device is provided. The method includes generating a circuit diagram representing connections among a supply voltage, a ground voltage, and a plurality of components included in the semiconductor device and displaying a plurality of layout restrictions on the circuit diagram by using a plurality of graphic symbols.

In an exemplary embodiment of the present inventive concept, the plurality of layout restrictions may include a restriction used when implementing wirings between the plurality of components on a printed circuit board.

In an exemplary embodiment of the present inventive concept, the plurality of layout restrictions may include a restriction used when implementing wirings between the ground voltage and the plurality of components on a printed circuit board.

In an exemplary embodiment of the present inventive concept, the plurality of layout restrictions may include a restriction used when implementing wirings between the supply voltage and the plurality of components on a printed circuit board.

In an exemplary embodiment of the present inventive concept, the plurality of graphic symbols may be stored in a graphic symbol library. The plurality of graphic symbols corresponds to the plurality of layout restrictions.

In an exemplary embodiment of the present inventive concept, displaying the plurality of layout restrictions may include displaying a beta ground on the circuit diagram by using a first graphic symbol. The beta ground may be formed on an outermost layer of a printed circuit board and may be connected to a main ground formed on an inner layer of the printed circuit board.

In an exemplary embodiment of the present inventive concept, displaying the plurality of layout restrictions may include displaying a pair of wirings on the circuit diagram by using a second graphic symbol. The pair of wirings may be coupled between at least two of the plurality of components and may transmit a differential signal.

In an exemplary embodiment of the present inventive concept, displaying the plurality of layout restrictions may include displaying wirings on the circuit diagram by using a third graphic symbol. The wirings may be coupled between at least two of the plurality of components and may have substantially the same length as each other.

In an exemplary embodiment of the present inventive concept, a maximum length and a maximum allowable deviation in length of each of the wirings may be displayed near the third graphic symbol.

In an exemplary embodiment of the present inventive concept, displaying the plurality of layout restrictions may include displaying a circuit loop on the circuit diagram by using a fourth graphic symbol. The circuit loop may include a passive element and at least one of the plurality of components.

In an exemplary embodiment of the present inventive concept, displaying the plurality of layout restrictions may include displaying a wiring on the circuit diagram by using a fifth graphic symbol. The wiring may directly connect at least one of the plurality of components to a main ground formed on an inner layer of a printed circuit board through a ground via.

In an exemplary embodiment of the present inventive concept, displaying the plurality of layout restrictions may include displaying a wiring on the circuit diagram by using a sixth graphic symbol. The wiring may be coupled between at least two of the plurality of components and may have a form of a stripline on an inner layer of a printed circuit board.

In an exemplary embodiment of the present inventive concept, displaying the plurality of layout restrictions may include displaying a wiring on the circuit diagram by using a seventh graphic symbol. The wiring may be coupled between at least two of the plurality of components and may have a ground shield.

In an exemplary embodiment of the present inventive concept, displaying the plurality of layout restrictions may include displaying a wiring on the circuit diagram by using an eighth graphic symbol. The wiring may be coupled between at least two of the plurality of components.

In an exemplary embodiment of the present inventive concept, displaying the plurality of layout restrictions may include displaying a wiring on the circuit diagram by using a ninth graphic symbol. The wiring may be formed in a planar form and may be coupled between the supply voltage and at least one of the plurality of components.

According to an exemplary embodiment of the present inventive concept, an apparatus for providing a design diagram of a semiconductor device is provided. The apparatus includes a graphic symbol library, a user interface, and a control unit. The graphic symbol library is configured to store a plurality of graphic symbols in association with a plurality of layout restrictions. The plurality of layout restrictions is used when implementing the semiconductor device on a printed circuit board. The user interface is configured to generate an input signal based on an input from a user. The control unit is configured to generate a circuit diagram representing connections among a supply voltage, a ground voltage and a plurality of components in the semiconductor device based on the input signal and to generate the design diagram by displaying at least one of the plurality of graphic symbols based on the input signal.

In an exemplary embodiment of the present inventive concept, the apparatus may further include a display unit. The plurality of graphic symbols and the plurality of layout restrictions may be displayed on the display unit.

According to an exemplary embodiment of the present inventive concept, a method for providing a design diagram of a semiconductor device is provided. The method includes generating a circuit diagram including connection information among a supply voltage, a ground voltage, and a plurality of components in the semiconductor device and displaying layout information of wirings among the supply voltage, the ground voltage, and the plurality of components on the circuit diagram by using a plurality of graphic symbols.

In an exemplary embodiment of the present inventive concept, the layout information may include a plurality of restrictions used when the wirings among the supply voltage, the ground voltage, and the plurality of components are implemented in a printed circuit board.

In an exemplary embodiment of the present inventive concept, the plurality of graphic symbols may be stored in a graphic symbol library, and the plurality of graphic symbols may correspond to the plurality of layout restrictions.

### BRIEF DESCRIPTION OF THE DRAWINGS

Illustrative, non-limiting exemplary embodiments of the present inventive concept will be more clearly understood from the following detailed description in conjunction with the accompanying drawings:

FIG. 1 is a flow chart illustrating a method for providing a design diagram of a semiconductor device according to an exemplary embodiment of the present inventive concept;

FIG. 2 is a block diagram illustrating an apparatus for providing a design diagram of a semiconductor device according to an exemplary embodiment of the present inventive concept;

FIGS. 3A to 11B are diagrams illustrating displaying a plurality of layout restrictions on a circuit diagram by using a plurality of graphic symbols in the method of FIG. 1 according to an exemplary embodiment of the present inventive concept; and

FIG. 12 is a diagram illustrating a graphic symbol library included in the apparatus of FIG. 2 according to an exemplary embodiment of the present inventive concept.

### DETAILED DESCRIPTION OF THE EMBODIMENTS

Various exemplary embodiments of the present inventive concept will be described more fully hereinafter with reference to the accompanying drawings. The present inventive concept may, however, be embodied in many different forms and should not be construed as limited to the embodiments set forth herein. Like reference numerals may refer to like elements throughout this application.

It will be understood that when an element is referred to as being “connected” or “coupled” to another element, it can be directly connected or coupled to the other element or intervening elements may be present.

As used herein, the singular forms “a,” “an” and “the” are intended to include the plural forms as well, unless the context clearly indicates otherwise.

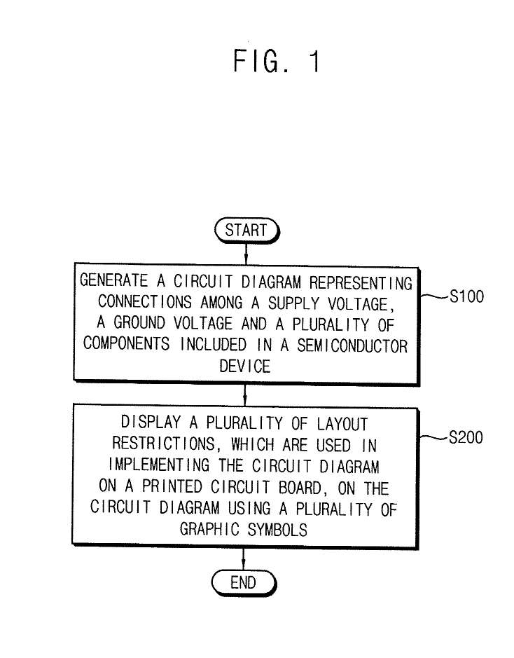

FIG. 1 is a flow chart illustrating a method for providing a design diagram of a semiconductor device according to an exemplary embodiment of the present inventive concept.

For example, the semiconductor device includes a plurality of components.

Referring to FIG. 1, a circuit diagram representing connections among a supply voltage, a ground voltage, and the plurality of components is generated (step S100). The plurality of components may include an intellectual property (IP) provided in a form of a chip. Connections between the plurality of components, connections between the plurality of components and the supply voltage, and connections between the plurality of components and the ground voltage may be included in the circuit diagram.

A plurality of layout restrictions is displayed on the circuit diagram by using a plurality of graphic symbols (step S200). The plurality of layout restrictions is used when implanting the circuit diagram on a printed circuit board. For example, the plurality of layout restrictions may include design guidelines for arranging and implementing the plurality of components and wirings that connect the plurality of components on the printed circuit board.

In an exemplary embodiment of the present inventive concept, the plurality of layout restrictions may include a restriction used when implementing wirings between the plurality of components on the printed circuit board.

In an exemplary embodiment of the present inventive concept, the plurality of layout restrictions may include a restriction used when implementing wirings between the ground voltage and the plurality of components on the printed circuit board.

In an exemplary embodiment of the present inventive concept, the plurality of layout restrictions may include a restriction used when implementing wirings between the supply voltage and the plurality of components on the printed circuit board.

In an exemplary embodiment of the present inventive concept, the plurality of graphic symbols may be stored in a graphic symbol library in association with the plurality of layout restrictions that corresponds to the plurality of graphic symbols, respectively. For example, the plurality of graphic symbols and the plurality of layout restrictions corresponding to the plurality of graphic symbols, respectively may be stored in the graphic symbol library. Each of the plurality of graphic symbols may represent a corresponding restriction intuitively.

A design diagram of a semiconductor device may include connections between components, connections between the components and the supply voltage, and connections between the components and the ground voltage and might not include a layout of the connections. As a semiconductor device becomes smaller and denser, an improved layout of the components and the wirings connecting the components, a supply voltage, and a ground voltage can increase a performance and a reliability of the semiconductor device.

As described above, in the method for providing a design diagram of a semiconductor device according to an exemplary embodiment of the present inventive concept, the plurality of layout restrictions, which is used when implementing the circuit diagram of the semiconductor device on the printed circuit board, is displayed on the circuit diagram by using the plurality of graphic symbols. Therefore, the method illustrated in FIG. 1 may provide the design diagram that effectively represents the layout information of the semiconductor device as well as the connection information of the semiconductor device.

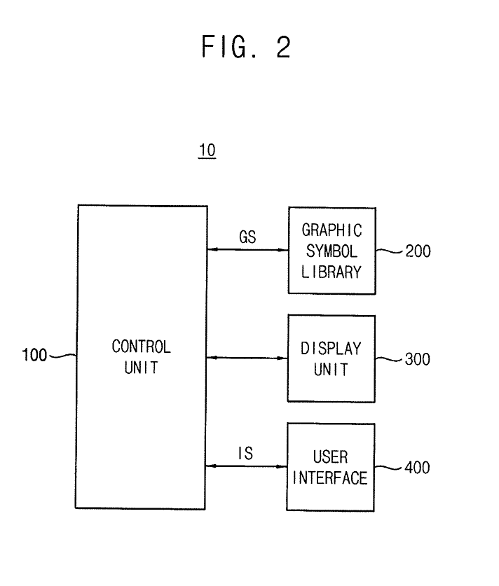

FIG. 2 is a block diagram illustrating an apparatus for providing a design diagram of a semiconductor device according to an exemplary embodiment of the present inventive concept.

Referring to FIG. 2, an apparatus 10 that provides a design diagram of a semiconductor device includes a control unit 100, a graphic symbol library 200, a display unit 300, and a user interface 400.

The graphic symbol library 200 stores a plurality of graphic symbols GS in association with a plurality of layout restrictions used when implementing the semiconductor device on a printed circuit board.

The user interface 400 generates an input signal IS based on an input from a user.

The control unit 100 generates the circuit diagram representing connections among a supply voltage, a ground voltage, and a plurality of components included in the semiconductor device based on the input signal IS, and displays the circuit diagram on the display unit 300.

In addition, the control unit 100 reads the plurality of graphic symbols GS and the plurality of layout restrictions corresponding to the plurality of graphic symbols GS, respectively, from the graphic symbol library 200, and displays the plurality of graphic symbols GS and the plurality of layout restrictions on the display unit 300. The user of the apparatus may select at least one of the plurality of graphic symbols GS displayed on the display unit 300, and the user interface 400 may generate the input signal IS based on the selection of the user. The control unit 100 generates the design diagram of the semiconductor device by displaying at least one of the plurality of graphic symbols GS on the circuit diagram based on the input signal IS received from the user interface 400, and displays the design diagram on the display unit 300.

The method for providing the design diagram of the semiconductor device of FIG. 1 may be performed by the apparatus 10 of FIG. 2.

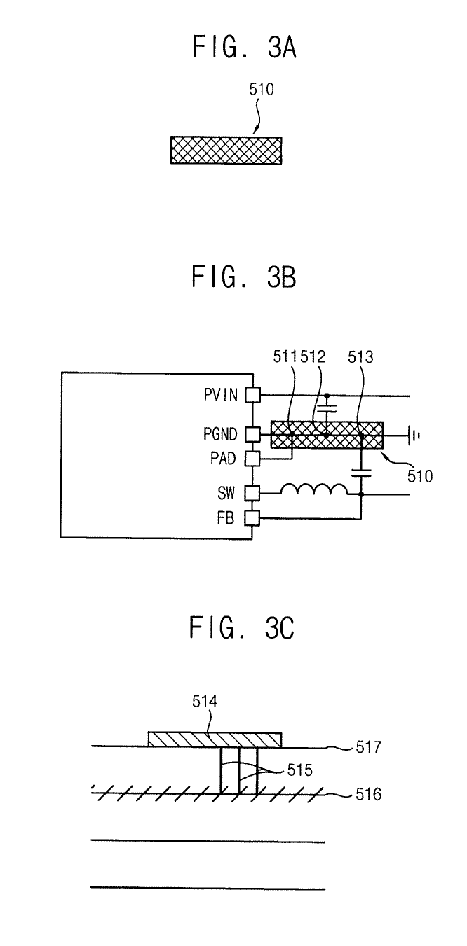

FIGS. 3A to 11B are diagrams illustrating displaying a plurality of layout restrictions on a circuit diagram by using a plurality of graphic symbols in the method of FIG. 1 according to an exemplary embodiment of the present inventive concept.

Hereinafter, exemplary embodiments of displaying the plurality of layout restrictions on the circuit diagram by using the plurality of graphic symbols GS will be described in detail with reference to FIGS. 3A to 11B.

FIG. 3A illustrates a first graphic symbol 510 corresponding to a beta ground. FIG. 3B illustrates a portion of a design diagram in which the first graphic symbol 510 is displayed on the circuit diagram according to an exemplary embodiment of the present inventive concept. FIG. 3C illustrates a cross-sectional view of a printed circuit board including the beta ground.

In FIG. 3C, the printed circuit board may include four layers as an example.

Referring to FIG. 3C, the beta ground 514 may be formed on an outermost layer 517 of the printed circuit board and may be connected to a main ground 516 through a plurality of ground vias 515. The main ground 516 may be formed on an inner layer of the printed circuit board. The beta ground 514 may be used to enhance an electromagnetic interference (EMI) performance.

The beta ground 514 may be displayed on the circuit diagram by using the first graphic symbol 510 of FIG. 3A.

For example, as illustrated in FIG. 3B, when the first graphic symbol 510 is displayed on the circuit diagram, the design diagram of FIG. 3B may represent a first layout restriction in which the beta ground 514 is required to be formed on the printed circuit board and nodes 511, 512 and 513 included in the first graphic symbol 510 are required to be connected to the beta ground 514.

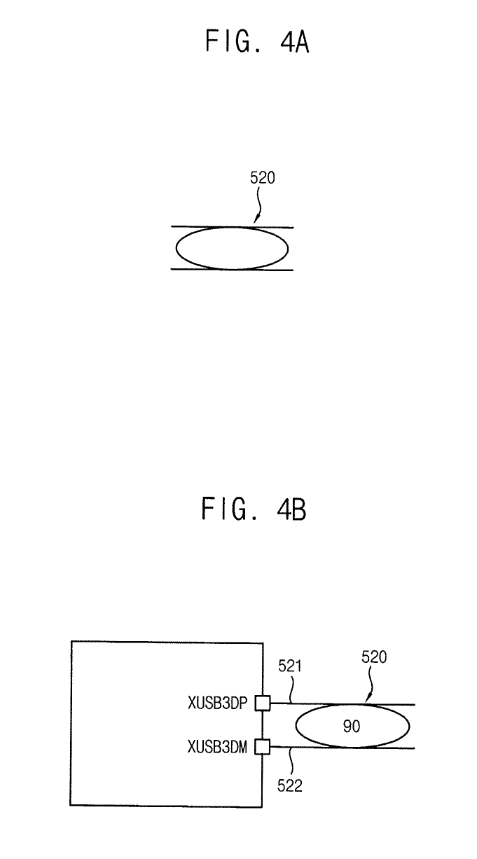

FIG. 4A illustrates a second graphic symbol 520 corresponding to a pair of wirings that transmits a differential signal. FIG. 4B illustrates a portion of a design diagram in which the second graphic symbol 520 is displayed on the circuit diagram according to an exemplary embodiment of the present inventive concept.

Among wirings coupled between the plurality of components included in the circuit diagram, a pair of wirings that transmits a differential signal may be displayed on the circuit diagram by using the second graphic symbol 520 of FIG. 4A.

For example, as illustrated in FIG. 4B, when two wirings 521 and 522 connected to a component of the circuit diagram transmits a differential signal, the second graphic symbol 520 may be displayed on the circuit diagram to represent the pair of the wirings 521 and 522 transmitting the differential signal.

In an exemplary embodiment of the present inventive concept, an impedance value of the pair of wirings represented by the second graphic symbol 520 may be displayed near the second graphic symbol 520 on the circuit diagram.

For example, as illustrated in FIG. 4B, when the second graphic symbol 520 is displayed on the circuit diagram and the impedance value 90 is displayed near the second graphic symbol 520, the design diagram of FIG. 4B may represent a second layout restriction in which the wirings 521 and 522 are required to have substantially the same length as each other to transmit the differential signal, and the pair of wirings 521 and 522 is required to have an impedance of 90 ohm.

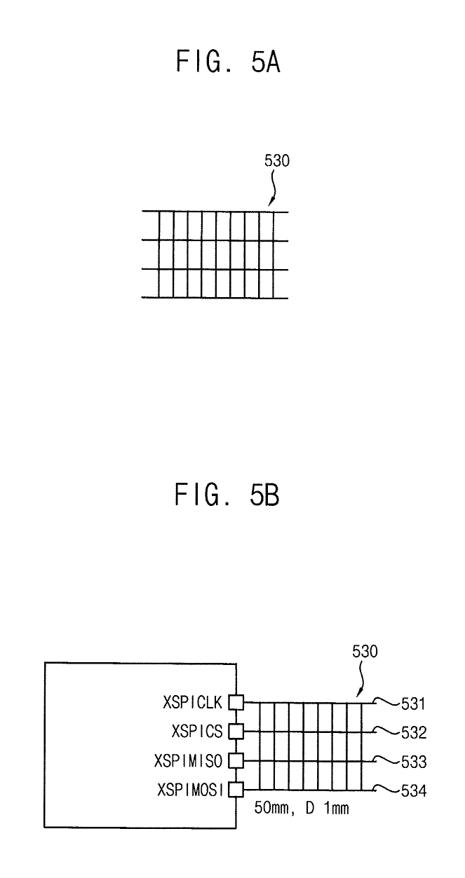

FIG. 5A illustrates a third graphic symbol 530 corresponding to wirings having substantially the same length. FIG. 5B illustrates a portion of a design diagram in which the third graphic symbol 530 is displayed on the circuit diagram, according to an exemplary embodiment of the present inventive concept.

Among wirings coupled between the plurality of components included in the circuit diagram, wirings that are required to have substantially the same length may be displayed on the circuit diagram by using the third graphic symbol 530 of FIG. 5A.

For example, as illustrated in FIG. 5B, when wirings 531, 532, 533, and 534 connected to a component of the circuit diagram are required to have substantially the same length as each other, the third graphic symbol 530 may be displayed on the circuit diagram to represent a group of the wirings 531, 532, 533, and 534.

In an exemplary embodiment of the present inventive concept, a maximum length and a maximum allowable deviation in length of the wirings represented by the third graphic symbol 530 may be displayed near the third graphic symbol 530 on the circuit diagram.

For example, as illustrated in FIG. 5B, when the third graphic symbol 530 is displayed on the circuit diagram and a maximum length of 50 mm and a maximum allowable deviation D in length of 1 mm are displayed near the third graphic symbol 530, the design diagram of FIG. 5B may represent a third layout restriction in which the wirings 531, 532, 533 and 534 are required to have substantially the same length as each other. In addition, in the third layout restriction, each length of the wirings 531, 532, 533 and 534 is required to be equal to or smaller than 50 mm, and a deviation D in length between the wirings 531, 532, 533 and 534 is required to be equal to or smaller than 1 mm.

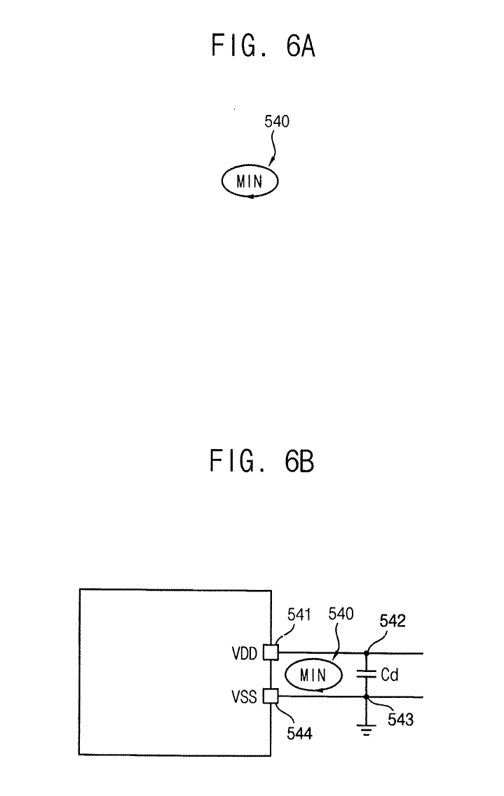

FIG. 6A illustrates a fourth graphic symbol 540 corresponding to a circuit loop that is required to be formed as short as possible. FIG. 6B illustrates a portion of a design diagram in which the fourth graphic symbol 540 is displayed on the circuit diagram according to an exemplary embodiment of the present inventive concept.

A circuit loop that includes a passive element and at least one of the plurality of components and is required to be formed as short as possible may be displayed on the circuit diagram by using the fourth graphic symbol 540 of FIG. 6A.

For example, as illustrated in FIG. 6B, when a decoupling capacitor Cd that is connected between a supply electrode VDD and a ground electrode VSS of a component included in the circuit diagram is required to be formed as close to the component as possible, the fourth graphic symbol 540 may be displayed in a circuit loop of the circuit diagram that is formed by nodes 541, 542, 543 and 544. As illustrated in FIG. 6B, when the fourth graphic symbol 540 is displayed in the circuit loop formed by the nodes 541, 542, 543 and 544, the design diagram of FIG. 6B may represent a fourth layout restriction in which the circuit loop is required to be formed as short as possible.

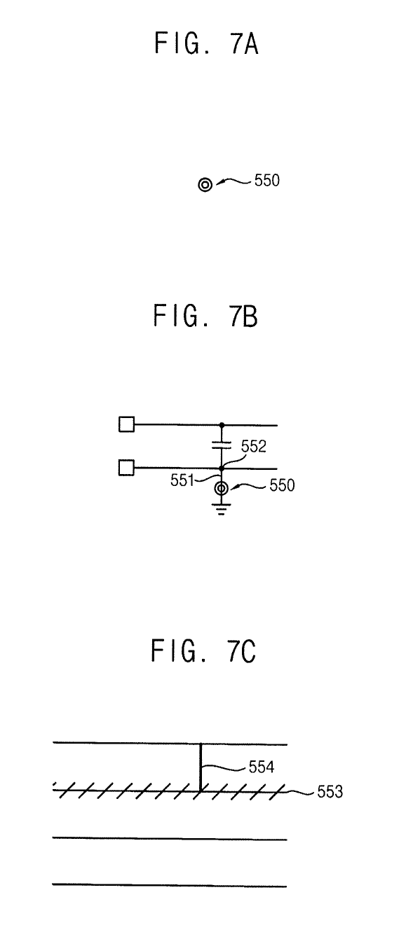

FIG. 7A illustrates a fifth graphic symbol 550 corresponding to a wiring that is directly connected to a main ground through a via. FIG. 7B illustrates a portion of a design diagram in which the fifth graphic symbol 550 is displayed on the circuit diagram according to an exemplary embodiment of the present inventive concept. FIG. 7C illustrates a cross-sectional view of a printed circuit board including the wiring that is directly connected to the main ground through the via.

In FIG. 7C, the printed circuit board may include four layers as an example.

Referring to FIG. 7C, a main ground 553 may be formed on an inner layer of the printed circuit board and a via 554 may be directly connected to the main ground 553.

Referring to FIGS. 7B and 7C, when a node 552 is required to be directly connected to the main ground 553 through the via 554 instead of being indirectly connected to the main ground 553 through a ground electrode of a component included in the circuit diagram, the fifth graphic symbol 550 of FIG. 7A may be displayed on a wiring 551 that connects the node 552 to the ground voltage. As illustrated in FIG. 7B, when the fifth graphic symbol 550 is displayed on the circuit diagram, the design diagram of FIG. 7B may represent a fifth layout restriction in which the wiring 551 on which the fifth graphic symbol 550 is displayed is required to be directly connected to the main ground 553 through the via 554.

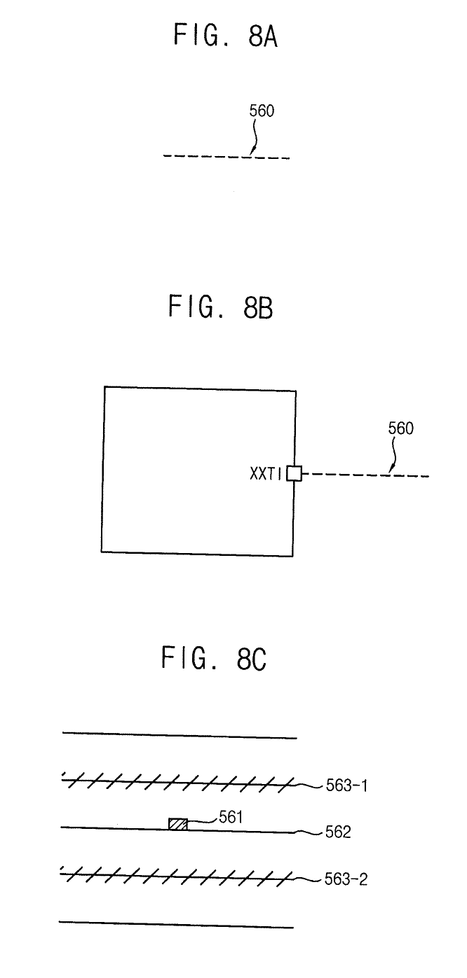

FIG. 8A illustrates a sixth graphic symbol 560 corresponding to a wiring that is required to have a form of a stripline. FIG. 8B illustrates a portion of a design diagram in which the sixth graphic symbol 560 is displayed on the circuit diagram according to an exemplary embodiment of the present inventive concept. FIG. 8C illustrates a cross-sectional view of a printed circuit board including the wiring having that is formed in a form of a stripline.

In FIG. 8C, the printed circuit board may include five layers as an example.

As illustrated in FIG. 8C, a first ground 563-1 and a second ground 563-2 may be formed on inner layers of the printed circuit board and a wiring 561 may be formed on a layer 562 between the first ground 563-1 and the second ground 563-2 to have a form of a stripline. The stripline may be used to enhance an electromagnetic interference (EMI) performance.

Referring to FIGS. 8B and 8C, among wirings coupled between the plurality of components included in the circuit diagram, the wiring 561 that is required to have a form of a stripline may be displayed on the circuit diagram by using the sixth graphic symbol 560 of FIG. 8A. As illustrated in FIG. 8B, when the sixth graphic symbol 560 is displayed on the circuit diagram, the design diagram of FIG. 8B may represent a sixth layout restriction in which the wiring 561 corresponding to the sixth graphic symbol 560 is required to have a form of a stripline.

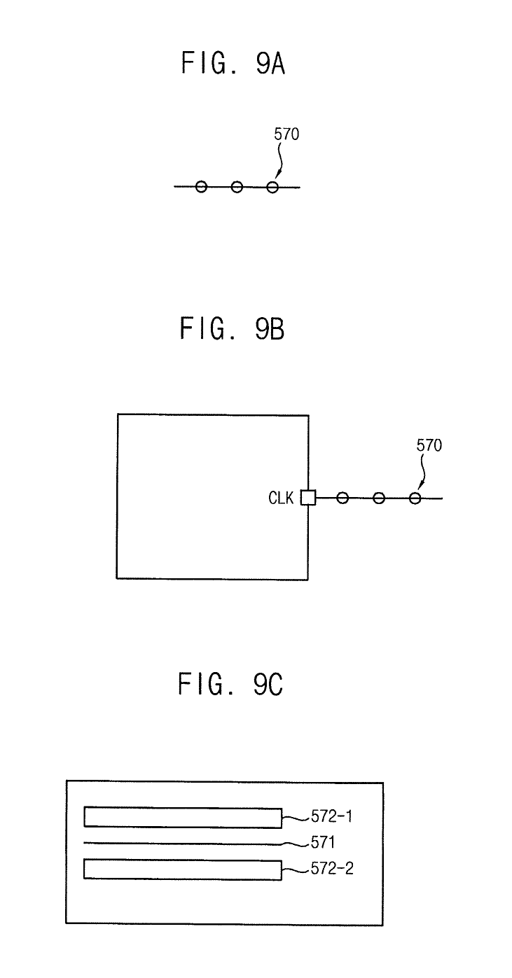

FIG. 9A illustrates a seventh graphic symbol 570 corresponding to a wiring that has a ground shield. FIG. 9B illustrates a portion of a design diagram in which the seventh graphic symbol 570 is displayed on the circuit diagram according to an exemplary embodiment of the present inventive concept. FIG. 9C illustrates a top view of a printed circuit board including the wiring having the ground shield.

As illustrated in FIG. 9C, a ground shield including a first ground wiring 572-1 and a second ground wiring 572-2 may be formed at both sides of a wiring 571. When the ground shield is formed around the wiring 571, a crosstalk between a signal transmitted through the wiring 571 and signals transmitted through other wirings may decrease. For example, the ground shield may be formed around a wiring (e.g., the wiring 571) transmitting a clock signal to decrease an effect of crosstalk on the clock signal.

Referring to FIGS. 9B and 9C, among wirings coupled between the plurality of components included in the circuit diagram, the wiring 571 around which the ground shield is required to be formed may be displayed on the circuit diagram by using the seventh graphic symbol 570 of FIG. 9A. As illustrated in FIG. 9B, when the seventh graphic symbol 570 is displayed on the circuit diagram, the design diagram of FIG. 9B may represent a seventh layout restriction in which the ground shield is required to be formed around the wiring 571 corresponding to the seventh graphic symbol 570.

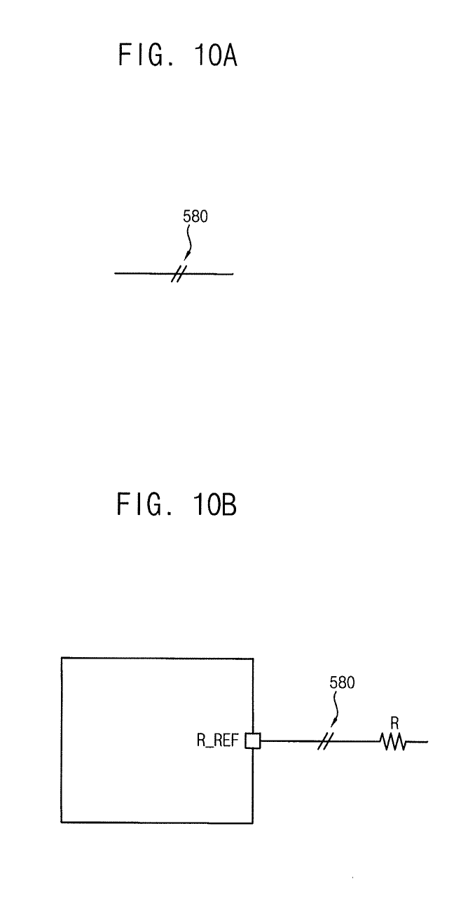

FIG. 10A illustrates an eighth graphic symbol 580 corresponding to a wiring that is required to be formed as short as possible. FIG. 10B illustrates a portion of a design diagram in which the eighth graphic symbol 580 is displayed on the circuit diagram according to an exemplary embodiment of the present inventive concept.

Among wirings coupled between the plurality of components included in the circuit diagram, a wiring that is required to be formed as short as possible may be displayed on the circuit diagram by using the eighth graphic symbol 580 of FIG. 10A.

For example, as illustrated in FIG. 10B, when a wiring connected between a resistor R and an electrode R_REF of a component of the circuit diagram is required to be formed as short as possible, the eighth graphic symbol 580 may be displayed on the circuit diagram to represent the wiring that is required to be formed as short as possible. As illustrated in FIG. 10B, when the eighth graphic symbol 580 is displayed on the circuit diagram, the design diagram of FIG. 10B may represent an eighth layout restriction in which the wiring corresponding to the eighth graphic symbol 580 is required to be formed as short as possible.

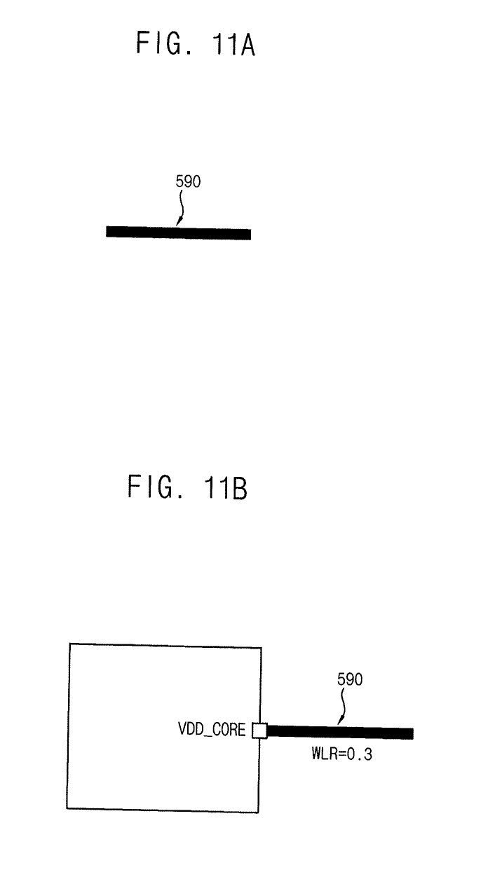

FIG. 11A illustrates a ninth graphic symbol 590 corresponding to a wiring that is required to have a planar form. FIG. 11B illustrates a portion of a design diagram in which the ninth graphic symbol 590 is displayed on the circuit diagram according to an exemplary embodiment of the present inventive concept.

Among wirings for providing the supply voltage to the plurality of components included in the circuit diagram, a wiring that is required to have the planar form instead of having a form of a line may be displayed on the circuit diagram by using the ninth graphic symbol 590 of FIG. 11A.

For example, as illustrated in FIG. 11B, when a wiring for providing the supply voltage to a supply electrode VDD_CORE of a component of the circuit diagram is required to have the planar form, the ninth graphic symbol 590 may be displayed on the circuit diagram to represent the wiring that is required to have the planar form.

In an exemplary embodiment of the present inventive concept, a minimum allowable value of a width-length ratio WLR of the wiring represented by the ninth graphic symbol 590 may be displayed near the ninth graphic symbol 590 on the circuit diagram. The width-length ratio WLR is a ratio of a width to a length of the wiring having the planar form.

For example, as illustrated in FIG. 11B, when the ninth graphic symbol 590 is displayed on the circuit diagram and the minimum allowable value of the width-length ratio WLR is displayed as 0.3 near the ninth graphic symbol 590, the design diagram of FIG. 11B may represent a ninth layout restriction in which the wiring corresponding to the ninth graphic symbol 590 is required to have the planar form and the width-length ratio WLR of the wiring is equal to or greater than 0.3.

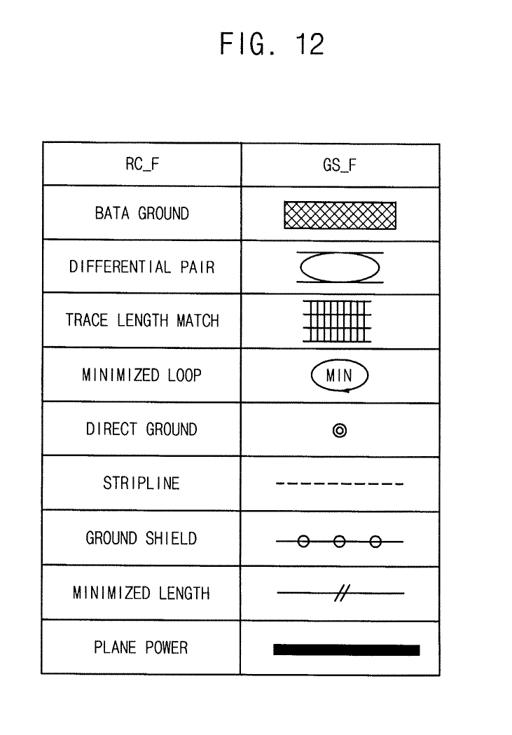

FIG. 12 is a diagram illustrating a graphic symbol library included in the apparatus of FIG. 2.

As described above, the graphic symbol library 200 stores the plurality of graphic symbols GS in association with the plurality of layout restrictions. The plurality of layout restrictions is used when implementing the semiconductor device on the printed circuit board.

For example, as illustrated in FIG. 12, the graphic symbol library 200 may include a layout restriction field RC_F and a graphic symbol field GS_F.

Referring to FIG. 12, contents (e.g., names) of the plurality of layout restrictions may be stored in the layout restriction field RC_F, and the plurality of graphic symbols GS corresponding to the plurality of layout restrictions, respectively, may be stored in the graphic symbol field GS_F. For example, as illustrated in FIG. 12, contents (e.g., names) of the first through ninth layout restrictions and the first through ninth graphic symbols 510, 520, 530, 540, 550, 560, 570, 580, and 590, which are described above with reference to FIGS. 3A to 11B, are stored in the layout restriction field RC_F and the graphic symbol field GS_F of the graphic symbol library 200, respectively.

Referring back to FIG. 2, the control unit 100 may display the contents of the plurality of layout restrictions and the plurality of graphic symbols GS, which are stored in the graphic symbol library 200, on the display unit 300.

For example, when a user of the apparatus 10 selects one of the plurality of graphic symbols GS displayed on the display unit 300 and a location of the circuit diagram at which a layout restriction corresponding to the selected graphic symbol GS is applied by using the user interface 400, the control unit 100 may display the selected graphic symbol GS on the location of the circuit diagram to generate the design diagram.

The method and apparatus for providing a design diagram of a semiconductor device by using the first through ninth layout restrictions and the first through ninth graphic symbols 510, 520, 530, 540, 550, 560, 570, 580, and 590 are described above with reference to FIGS. 1 to 12. However, an exemplary embodiment of the present inventive concept is not limited thereto. For example, the method and apparatus for providing a design diagram of a semiconductor according to an exemplary embodiment of the present inventive concept may use other layout restrictions and other graphic symbols.

As described above with reference to FIGS. 1 to 12, the method and apparatus for providing a design diagram of a semiconductor according to an exemplary embodiment of the present inventive concept may provide a design diagram that effectively represents information pertaining to layouts and connections of the plurality of components of the semiconductor device as well as the connection information of the plurality of components.

According to an exemplary embodiment of the present inventive concept, a method for providing a design diagram of a semiconductor device that includes a circuit diagram together with layout information for implementing the circuit diagram on a printed circuit board is provided.

According to an exemplary embodiment of the present inventive concept, an apparatus for providing a design diagram of a semiconductor device that includes a circuit diagram together with layout information for implementing the circuit diagram on a printed circuit board is provided.

The foregoing is illustrative of the present inventive concept and is not to be construed as limiting thereof. Although a few exemplary embodiments have been described, it will be understood by those skilled in the art that various modifications in form and details may be made thereto without departing from the spirit and scope of the present inventive concept as defined by the claims.

What is claimed is:

1. A method for providing a design diagram of a semiconductor device, the method comprising:
generating a circuit diagram representing connections among a supply voltage, a ground voltage, and a plurality of components in the semiconductor device; and
displaying a plurality of layout restrictions on the circuit diagram by using a plurality of graphic symbols.

2. The method of claim 1, wherein the plurality of layout restrictions includes a restriction used when implementing wirings between the plurality of components on a printed circuit board.

3. The method of claim 1, wherein the plurality of layout restrictions includes a restriction used when implementing wirings between the ground voltage and the plurality of components on a printed circuit board.

4. The method of claim 1, wherein the plurality of layout restrictions includes a restriction used when implementing wirings between the supply voltage and the plurality of components on a printed circuit board.

5. The method of claim 1, wherein the plurality of graphic symbols is stored in a graphic symbol library, and the plurality of graphic symbols corresponds to the plurality of layout restrictions.

6. The method of claim 1, wherein displaying the plurality of layout restrictions includes displaying a beta ground on the circuit diagram by using a first graphic symbol,
wherein the beta ground is formed on an outermost layer of a printed circuit board and is connected to a main ground on an inner layer of the printed circuit board.

7. The method of claim 1, wherein displaying the plurality of layout restrictions includes displaying a pair of wirings on the circuit diagram by using a second graphic symbol,
wherein the pair of wirings is coupled between at least two of the plurality of components and transmits a differential signal.

8. The method of claim 1, wherein displaying the plurality of layout restrictions includes displaying wirings on the circuit diagram by using a third graphic symbol,
wherein the wirings are coupled between at least two of the plurality of components and have substantially the same length as each other.

9. The method of claim 8, wherein a maximum length and a maximum allowable deviation in length of each of the wirings are displayed near the third graphic symbol.

10. The method of claim 1, wherein displaying the plurality of layout restrictions includes displaying a circuit loop on the circuit diagram by using a fourth graphic symbol,
wherein the circuit loop includes a passive element and at least one of the plurality of components.

11. The method of claim 1, wherein displaying the plurality of layout restrictions includes displaying a wiring on the circuit diagram by using a fifth graphic symbol,
wherein the wiring connects at least one of the plurality of components to a main ground formed on an inner layer of a printed circuit board through a ground via.

12. The method of claim 1, wherein displaying the plurality of layout restrictions includes displaying a wiring on the circuit diagram by using a sixth graphic symbol,
wherein the wiring is coupled between at least two of the plurality of components and has a form of a stripline on an inner layer of a printed circuit board.

13. The method of claim 1, wherein displaying the plurality of layout restrictions includes displaying a wiring on the circuit diagram by using a seventh graphic symbol,
wherein the wiring is coupled between at least two of the plurality of components and has a ground shield.

14. The method of claim 1, wherein displaying the plurality of layout restrictions includes displaying a wiring on the circuit diagram by using an eighth graphic symbol,
wherein the wiring is coupled between at least two of the plurality of components.

15. The method of claim 1, wherein displaying the plurality of layout restrictions includes displaying a wiring on the circuit diagram by using a ninth graphic symbol,
wherein the wiring has a planar form and is coupled between the supply voltage and at least one of the plurality of components.

16. An apparatus for providing a design diagram of a semiconductor device, comprising:
a graphic symbol library configured to store a plurality of graphic symbols in association with a plurality of layout restrictions, wherein the plurality of layout restrictions is used when implementing the semiconductor device on a printed circuit board;
a user interface configured to generate an input signal based on an input from a user; and
a control unit configured to generate a circuit diagram representing connections among a supply voltage, a ground voltage, and a plurality of components in the semiconductor device based on the input signal and to generate the design diagram by displaying at least one of the plurality of graphic symbols based on the input signal.

17. The apparatus of claim 16, further comprising:
a display unit on which the plurality of graphic symbols and the plurality of layout restrictions are displayed.

18. A method for providing a design diagram of a semiconductor device, the method comprising:
generating a circuit diagram including connection information among a supply voltage, a ground voltage, and a plurality of components in the semiconductor device; and
displaying layout information of wirings among the supply voltage, the ground voltage, and the plurality of components on the circuit diagram by using a plurality of graphic symbols.

19. The method of claim 18, wherein the layout information includes a plurality of restrictions used when the wirings among the supply voltage, the ground voltage, and the plurality of components are implemented in a printed circuit board.

20. The method of claim 19, wherein the plurality of graphic symbols is stored in a graphic symbol library, and the plurality of graphic symbols corresponds to the plurality of layout restrictions.
